(19) United States
(12) Patent Application Publication
(10) Pub. No.: US 2012/0131024 A1
(43) Pub. Date: May 24, 2012

(54) APPARATUS AND METHOD FOR PROVIDING CONTACT INFORMATION AND PORTABLE TERMINAL USING SAME

(76) Inventor: Soo Min Park, Seoul (KR)

(21) Appl. No.: 13/386,416

(22) PCT Filed: Jul. 30, 2009
(86) PCT No.: PCT/KR2009/004250

§ 371 Date: Jan. 21, 2012

(51) Int. Cl. G06F 17/30

(52) U.S. Cl. 707/754; 707/758; 707/E17.059; 707/E17.069

(57) ABSTRACT

A messaging information providing apparatus includes an input unit for receiving text from a user; and a messaging information extraction unit for extracting messaging information of each management item contained in the text by matching the text against messaging information keywords stored in a keyword database by management item, so that input and management of the messaging information can be easily performed.

### TECHNICAL FIELD

The present invention relates to an apparatus and a method for providing messaging information and a portable terminal using the same, and more specifically, to an apparatus and a method for providing messaging information and a portable terminal using the same, which can easily provide the messaging information.

### BACKGROUND ART

Generally, secretaries do a variety of works for their bosses. Although there is software which automates only some parts of the secretary works such as schedule management and contact information (address book) management, software which comprehensively supports the secretary works does not exist yet.

In addition, although an address book management program has a function of searching for and outputting an address of a person when a user contacts with the person stored in the address book management program, the program does not have a function of outputting the address in association with content of a message received when a person stored in the address book management program makes a contact with the user.

Accordingly, when the secretaries exchange various kinds of messaging information such as details of a phone call, a mail, a fax, an e-mail or the like which takes the largest portion of the works they do on behalf of the bosses, manually writes details of the message on a note or a diary, and transfers the message to the bosses or makes a report on the message, the secretaries make an effort to manually rewrite the message on a note or the like.

That is, if a person named Hong Gil-dong asks for making an appointment to have a lunch tomorrow, it is possible to output the title and the contact information of the person using an address book. However, since there is no way to output details of the phone call requesting to have a lunch tomorrow together with the title and the contact information, details of the phone call should be separately informed using a note, and thus efficiency of the work is lowered.

Although programs supporting a schedule management function (daily schedule, weekly schedule, or monthly schedule management) or an address book management function have been developed using a program such as the Outlook Express in view of the problem, the programs also have a problem in that although they support the schedule and address book management functions, they do not support at all a function for a work related to management of messaging information, which is the most important part of the secretary works.

Furthermore, such a problem should be urgently solved taking into account the reality that the secretary works increase be used among general users for their schedule management or the like.

### DISCLOSURE OF INVENTION

### Technical Problem

Therefore, the present invention has been made view of the above problems, and it is an object of the present invention to provide an apparatus and a method for providing messaging information and a portable terminal using the same, which can easily provide the messaging information.

### Technical Solution

To accomplish the above object, according to one aspect of the present invention, there is provided a messaging information providing apparatus comprising: an input unit for receiving text from a user; and a messaging information extraction unit for extracting messaging information of each management item contained in the text by matching the text against messaging information keywords stored in a keyword database by management item.

At this point, the messaging information providing apparatus may further comprise a preprocessing unit for filtering messages unrelated to the messaging information using the keyword database and transmitting the filtered text to the messaging information extraction unit, after analyzing the text inputted by the user.

In addition, the messaging information providing apparatus may further comprise a display unit for displaying, by management item, the messaging information extracted by the messaging information extraction unit, and in this case, if the user manually inputs the text in a displayed management item, the keyword database additionally stores the manually inputted text as a keyword of the management item.

In addition, the messaging information providing apparatus may further comprise a messaging information storage unit for storing, by management item, the messaging information extracted by the messaging information extraction unit.

In addition, the management item may include at least one of message content, an address, and a schedule.

In addition, the text may contain special characters set for each management item in the keyword database.

According to another aspect of the present invention, there is provided a portable terminal using a messaging information providing apparatus, the terminal comprising: a messaging information input unit provided with an input unit for receiving text from a user and a messaging information extraction unit for extracting messaging information of each management item contained in the text by matching the text against messaging information keywords stored in a keyword database by management item; a messaging information storage unit for storing, by management item, the messaging information extracted by the messaging information extraction unit; a messaging information management unit for driving a process related to messaging information of a management item selected by the user, in association with messaging information of other management items extracted from the same text; and a communication unit for transmitting and receiving the messaging information through a mobile communication network.

At this point, the management item may include at least an appointment date, an appointment place, and content of appointment, and the messaging information management unit may extract and display messaging information associated within the management items and transmit the messaging information to outside through the communication unit depending on a user's selection.

In addition, the communication unit may receive messaging information from outside, and if the received messaging information corresponds to management items containing at least an appointment date, an appointment place, and content of appointment, the messaging information management unit may store the messaging information in the messaging information storage unit, and if one of appointment date messaging information, appointment place messaging information, and appointment content messaging information is selected, the messaging information management unit may display the other information in association with the selected information.

The messaging information management unit may store call connection numbers of one or more receiver terminals, which are targets for transmitting a result of the process, in a receiver terminal group, and edit the receiver terminal group and transmit an additional process to the receiver terminal group upon a request of the user.

According to another aspect of the present invention, there is provided a messaging information management system comprising: a messaging information input module provided with an input unit for receiving text from a user and a messaging information extraction unit for extracting messaging information of each management item contained in the text by matching the text against messaging information keywords stored in a keyword database by management item; a messaging information storage module for storing, by management item, the messaging information extracted by the messaging information extraction unit; a messaging information management module for driving a process related to messaging information of a management item selected by the user, in association with messaging information of other management items extracted from the same text; and a display module for displaying a result of the process driven by the messaging information management module.

At this point, the process may include at least any one of contact information display, schedule display, and appointment display.

In addition, the input unit of the messaging information input module and the display module may be disposed in a same terminal.

In addition, the messaging information extraction unit of the messaging information input module, the messaging information storage module, the messaging information management module, and the keyword database may be provided in a server, and the server may include an authentication module for allowing access to the server through a user's authentication.

In addition, the messaging information storage module may embed a connector associated with other connectors in each of the extracted messaging information and store the messaging information by management item, and the messaging information management module may acquire messaging information associated with the messaging information selected by the user using the connector.

According to another aspect of the present invention, there is provided a messaging information providing method comprising the steps of: receiving text from a user; filtering messages unrelated to messaging information from the received text using a keyword database previously storing keywords of the messaging information; and extracting messaging information of each management item contained in the filtered text by comparing the filtered text with the messaging information keywords stored in the keyword database by management item.

According to another aspect of the present invention, there is provided a messaging information management method comprising the steps of: receiving text from a user; filtering messages unrelated to messaging information from the received text using a keyword database previously storing keywords of the messaging information; extracting messaging information of each management item contained in the filtered text by comparing the filtered text with the messaging information keywords stored in the keyword database by management item; embedding a connector associated with other connectors in each of the extracted messaging information, and storing the messaging information embedded with the connector by management item; driving a process related to messaging information of a management item selected by the user; driving the process in association with messaging information of other management items associated with the selected messaging information through the connector; and outputting a result of the driven process.

At this point, the messaging information management method may further comprise the step of authenticating a user before the text input step.

In addition, the process may include at least any one of contact information display, schedule display, and appointment display.

In addition, the management item may include at least one of message content, an address, and a schedule.

According to another aspect of the present invention, there is provided a text analysis method comprising the steps of: receiving text through a terminal; extracting a special character defined for each management item from the text; and storing a character string starting from a character next to the extracted special character to a character before a next special character to be correspondent to a management item which defines the extracted special character.

In addition, the text analysis method may comprise the steps of: receiving text through a terminal; extracting a word defined for each management item from the text; and storing a character string following the extracted word without a space character to be correspondent to the management item which defines the extracted word.

At this point, the management item may include at least one of a time, a place, a topic, and others.

In addition, the extracted word may be positioned at an end of the character string.

In addition, the extracted word may be a longest word among a plurality of words containing a same syllable.

As described above, the apparatus and method for providing messaging information, and the portable terminal using the same according to the present invention analyze text inputted from a user and extract messaging information for each management item, and thus the messaging information may be easily provided and managed. In addition, the text analysis method according to the present invention may be applied to analyze the text inputted by the user and extract the messaging information for each management item using the apparatus and method for providing messaging information and the portable terminal using the same.

### Advantageous Effects

According to the present invention, it is easy to manage and edit messaging information.

### BRIEF DESCRIPTION OF THE DRAWINGS

FIG. 1 is a block diagram showing a messaging information providing apparatus according to an embodiment related to the present invention.

FIG. 2 is a block diagram showing a messaging information providing apparatus according to another embodiment related to the present invention.

FIG. 3 is a block diagram showing a messaging information providing apparatus according to still another embodiment related to the present invention.

FIG. 4 is a block diagram showing a portable terminal using a messaging information providing apparatus related to the present invention.

FIG. 5 schematically shows a view of processing text inputted into a portable terminal using a messaging information providing apparatus related to the present invention.

FIG. 6 schematically shows a view of managing messaging information extracted from a portable terminal using a messaging information providing apparatus related to the present invention.

FIG. 7 schematically shows another view of managing messaging information extracted from a portable terminal using a messaging information providing apparatus related to the present invention.

FIG. 8 schematically shows a view of a general portable terminal receiving a message transmitted from a portable terminal using a messaging information providing apparatus related to the present invention.

FIG. 9 is a block diagram showing a messaging information management system related to the present invention.

FIG. 10 is a flowchart illustrating a messaging information providing method related to the present invention.

FIG. 11 is a flowchart illustrating a messaging information management method related to the present invention.

### DESCRIPTION OF SYMBOLS

110, 211, 311 . . . : Input unit
130, 213, 313 . . . : Messaging information extraction unit
170, 230, 330 . . . : Messaging information storage unit
250 . . . : Messaging information management unit

### BEST MODE FOR CARRYING OUT THE INVENTION

The messaging information described in the present invention refers to information related to a user's schedule such as a phone number, a name, a time, a place, and main content desired to inform.

The preferred embodiments of an apparatus and a method for providing messaging information and a portable terminal using the same related to the present invention will be hereafter described in detail.

FIG. 1 is a block diagram showing a messaging information providing apparatus according to an embodiment related to the present invention.

Referring to FIG. 1, the messaging information providing apparatus according to the present embodiment includes an input unit 110 for receiving text from a user; and a messaging information extraction unit 130 for extracting messaging information of each management item contained in the text by matching the text against messaging information keywords stored in a keyword database (not shown) by management item.

The input unit 110 may be configured with a keyboard, a keypad, a mouse, and the like as a device for receiving certain text from a user. In addition, the text may be text received through a wired or wireless network. The text is formed with character strings having a certain meaning and may contain messaging information. The messaging information contained in the text may exist so as to be identified as being messaging information or may exist to be mixed with messages other than the messaging information.

The messaging information extraction unit 130 receives the text inputted through the input unit and extracts the messaging information. The messaging information extraction unit may be automatically driven or driven by a user's selection.

In order to extract the messaging information corresponding to a time, a place, and message content from the inputted text, character strings corresponding to the messaging information and the other character strings should be identified from the character strings constructing the text. A text parsing technique may be used in order to distinguish the character strings.

In the present embodiment, the messaging information extraction unit extracts the messaging information of each management item contained in the text by matching the text against messaging information keywords stored in the keyword database by management item. To this end, the keyword database sets management items, which are the upper concept of the messaging information to be provided, and stores messaging information keywords corresponding to each of the management items. For example, the keyword database may define message content, an address (a place) and a schedule (a time) as the management items and set a specific postpositional word or an adjective representing a name, a location and a direction of each place shown on a map as a messaging information keyword of the address (place). In the case of the postpositional word, the management items should be set so as to extract characters excluding the specific postpositional word as messaging information from a character string attached with the specific postpositional word, and the adjective should be set in the same manner as the postpositional word. The messaging information extraction unit may extract messaging information of each management item from the text where the time, the place, and the message content are mixed together.

According to the present embodiment, the messaging information of each management item can be extracted by analyzing the text inputted by the user. Accordingly, the user may input the messaging information in a method of inputting a general character message or creating a document, instead of inputting corresponding messaging information in a corresponding management item, while selecting a time, a place, or message content from an item menu. In addition, previously stored general text or a received character message can be extracted and managed as messaging information.

In addition, since the messaging information is extracted for each management item, the messaging information can be easily edited and managed.

The messaging information keywords related to the management items such as a time, a place, and the like among the management items described above can be set easily, and corresponding messaging information can be extracted reliably using the messaging information keywords. However, it is difficult in reality to set messaging information keywords of management items that are innumerably generated by the user, such as message content.

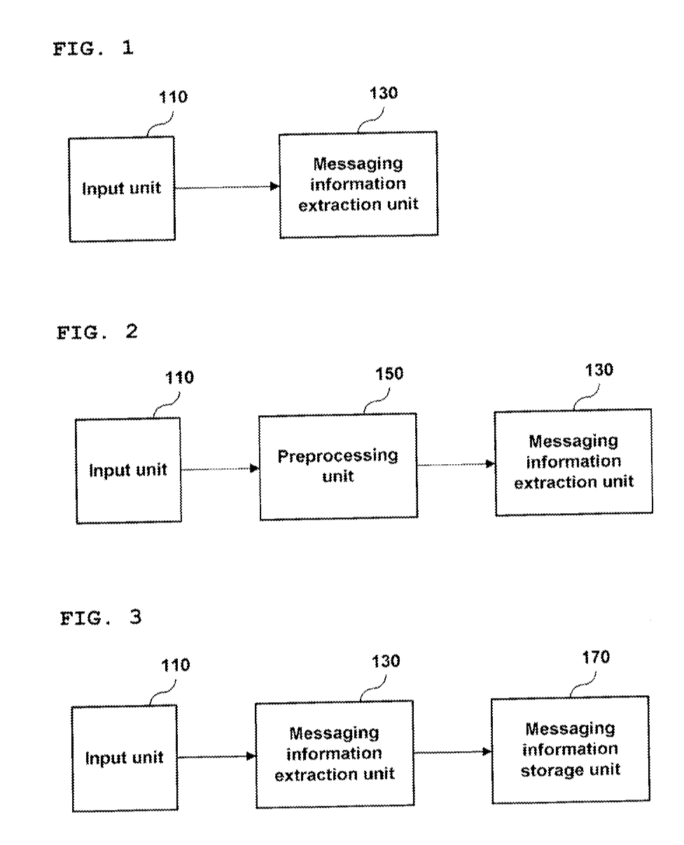

FIG. 2 is a block diagram showing a messaging information providing apparatus according to another embodiment related to the present invention.

The messaging information providing apparatus largely includes an input unit 110, a messaging information extraction unit 130, and a preprocessing unit 150 positioned between the input unit and the messaging information extraction unit.

The input unit 110 and the messaging information extraction unit 130 are the same as described above, and they will not be described.

The preprocessing unit 150 analyzes the text inputted by the user, filters messages unrelated to the messaging information using the keyword database, and transmits the filtered text to the messaging information extraction unit.

The filtering is accomplished through the keyword database. Specifically, character strings other than the character string matching to the messaging information keywords of the keyword database can be deleted from the text, and at this point, the deleted character strings are separately stored.

The messaging information extraction unit receiving the filtered text (together with the deleted character strings) may extract messaging information keywords such as a time, a place and the like and process the deleted character strings as messaging information representing the message content. It is apparent that special characters and various postpositional words may be excluded from the deleted character strings.

As another method, the filtering is also accomplished by storing filtering keywords in the keyword database and deleting character strings matching to the stored filtering keywords. Special characters and postpositional words may be examples of the filtering keywords.

The messaging information extraction unit receiving the filtered text extracts messaging information that is easy to extract through the messaging information keywords such as a time, a place and the like in the first step and then process character strings remaining after the extraction as messaging information representing the message content.

In summary, the preprocessing unit for filtering the inputted text is disposed between the input unit and the messaging information extraction unit, and thus it is possible to extract further reliable management items, and it is easy to extract messaging information such as message content to which messaging information keywords of the keyword database are difficult to be applied.

The messaging information providing apparatus described above may additionally include a display unit (not shown) for displaying, by management item, the messaging information extracted by the messaging information extraction unit. In this case, when the user manually inputs the text in a displayed management item, the keyword database may add the manually inputted text as a keyword of the management item. Accordingly, since the user may update and edit the keyword database, a keyword database optimized to a user's environment may be created.

It is described below a case where text such as “

[symbol]

[symbol]

3

[symbol]

### T&S Plan B

˜˜˜ (Today PM 3:00 o'clock, Summons a meeting in relation to T&S Plan B at conference room of headquarter, Materials to be prepared is the same as before, Members of related departments are requested to participate˜˜˜)” is inputted through the input unit.

The preprocessing unit filters special characters such as ‘˜˜˜’ and postpositional words such as ‘

[symbol]

’ and ‘ [symbol]
’. At this point, special characters such as ‘&’, ‘%’ and ‘$’ that may be possibly contained in the message content may be excluded from the filtering.

If management items are a time, a place, and message content, the messaging information extraction unit receiving the filtered text extracts messaging information of each management item from the text as shown below and displays the messaging information through the display unit as needed.

Date and Time: Today PM 3:00 o'clock

Place: Conference room, Headquarter

Message content: Summons a meeting in relation to T&S Plan B, Materials to be prepared is the same as before, Members of related departments are requested to participate.

If the management items are an address, a time, a place, a topic, and others, the messaging information may be extracted as shown below.

Address: Phone number (automatically recognized)

Date and Time: Today (Jul. 1st, 2009) PM 3:00 o'clock

Place: Conference room, Headquarter

Topic: Summon a Meeting in relation to T&S Plan B

Others: Material's to be prepared is the same as before, Members of related departments are requested to participate.

Describing in detail, it is understood that today's date ‘Jul. 1^{St}, 2009’ is added to the original text ‘Today’, and an address'including a phone number which is not contained in the inputted text or an automatically recognized phone number is inserted in the management item ‘address’. It is to prevent confusion that can be occurred if the messaging information is confirmed after a certain time period has passed. If the user inputs text such as ‘this day’ or ‘today’ as messaging information of time, it is unknown the exact date of ‘today’ if the messaging information is confirmed at a later time. Accordingly, if there is messaging information that needs to be expressed based on a specific date such as ‘this day’, ‘today’ or ‘tomorrow’, the messaging information extraction unit may embed additional information in the messaging information.

It is described above that a text analysis can be applied to extract messaging information using the keyword database, and the longest match, the shortest match, a combination of the longest match and the shortest match, and a method of using special characters may be applied to the text analysis.

When a keyword is matched to the character string ‘Summons a meeting in relation to’, the longest match tries matching the keyword to the entire ‘Summons a meeting in relation to’, whereas the shortest match tries matching the keyword to the words that are separated (by a space character) such as ‘relation’, ‘meeting’, and ‘summons’. It is possible to combine the longest match and the shortest match by applying the longest match or the shortest match to different management items. The examples described above are literally exemplary expressions, and both the longest match and the shortest match may use a space character as a delimiter. This will be described below.

The method of using special characters is a method of assigning a special character to a corresponding management item and extracting messaging information corresponding to each management item using the special character. For example, if ‘#’ is assigned to a time management item, ‘*’ is assigned to a place management item, ‘̂’ is assigned to a topic management item, and ‘!’ is assigned to other management item, a user needs to input text such as ‘#Today PM 3:00 o'clock*conference room of headquarter̂Summons a meeting in relation to T&S Plan B!Materials to be prepared is the same as before’ in order to extract messaging information shown below. Definitions of the special symbols (special characters) representing the management items are stored in the keyword database. That is, the text may be inputted to contain special characters set for respective management items stored in the keyword database.

Date and Time: Today PM 3:00 o'clock

Place: Conference room, Headquarter

Topic: Summons a meeting in relation to T&S Plan B

Others: Materials to be prepared is the same as before

In summary, the text analysis method for analyzing text in order to extract messaging information may include the steps of inputting the text into a terminal, extracting special characters defined for respective management items from the text, and storing a character string starting from a character next to an extracted special character to a character before the next special character to be correspondent: to a management item which defines the extracted special character. Here, the messaging information providing apparatus corresponds to a kind of terminal from the viewpoint of text analysis.

The management item may include at least one of a time, a place, a topic, and others.

When the special characters are applied, it may be preferable to recognize generally used characters since the user are required to be skilled. Therefore, text analysis using the longest match or the shortest match described above may applied.

If both the longest match and the shortest match use a space character as a delimiter, they commonly includes the steps of inputting text into a terminal, extracting a word defined for each management item from the text, and storing a character string following the extracted word without a space character to be correspondent to the management item which defines the extracted word. For example, if ‘o'clock’ defined as a time management item is extracted from text ‘3:00 o'clock at meeting room’, ‘3:00 o'clock’ containing ‘o'clock’ is separated from the ‘meeting room’ by the space character and stored to be correspondent to the time management item defined by ‘o'clock’.

Words defined as a time management item among the extracted words include this day, today, tomorrow, next day, the day after today, the day after tomorrow, two days after today, AM, PM, night, dawn, hour, minute, noon, midnight and the like.

Words defined as a place management item include Dong, Ho, Beonji, Ga, Myon, Eub, Ri, floor, exit, entrance, direction, bound, meeting room, office, park, hail and the like.

Words defined as a topic management item include conference, summon, inspection, social meeting, chatting, interview, meeting and the like.

The other words can be defined as other management item.

In the case of Korean text, a word representing a time or a place such as ‘

[symbol]

’ or ‘ [symbol]
’ is positioned at the end of a character string separated by a space character. Accordingly, the extracted word is preferably positioned at the end of an uninterrupted character string. In this manner, a word containing ‘ [symbol]
’ or the like positioned at a position other than the end of the character string may not be processed as a word defined for a management item. It is apparent that since the position of a character representing a time or a place may be different depending on the language of a corresponding country, the methods should be adaptively applied.

Here, the extracted word may be the longest word among a plurality of words containing the same syllable, and this process is referred to as the longest match. This is advantageous when the words contain the same syllable while defining different management items. For example, if there are ‘o'clock’ defining a time management item and ‘o'clock direction’ defining a place management item, according to the shortest match, ‘o'clock direction’ is processed in the same manner as ‘o'clock’, and thus ‘o'clock direction’ is processed as a time management item. However, according to the longest match, if ‘o'clock direction’ is matched to and recognized as two cases of ‘o'clock’ and ‘o'clock direction’, the longer matching word ‘o'clock direction’ is selected, and thus a character string connected in front of ‘o'clock direction’ without a space character is stored as a place management item.

If the time, place, topic, and others are not distinctively separated, they are stochastically separated using the shortest matching technique.

As described above, messaging information is extracted for each management item from the text inputted by the user, and the messaging information is stored through a separate messaging information storage unit 170 so as to be edited at a later time. That is, the messaging information extracted by the messaging information extraction unit may be stored through the messaging information storage unit as shown in FIG. 3, and at this point, the messaging information may be stored by management item.

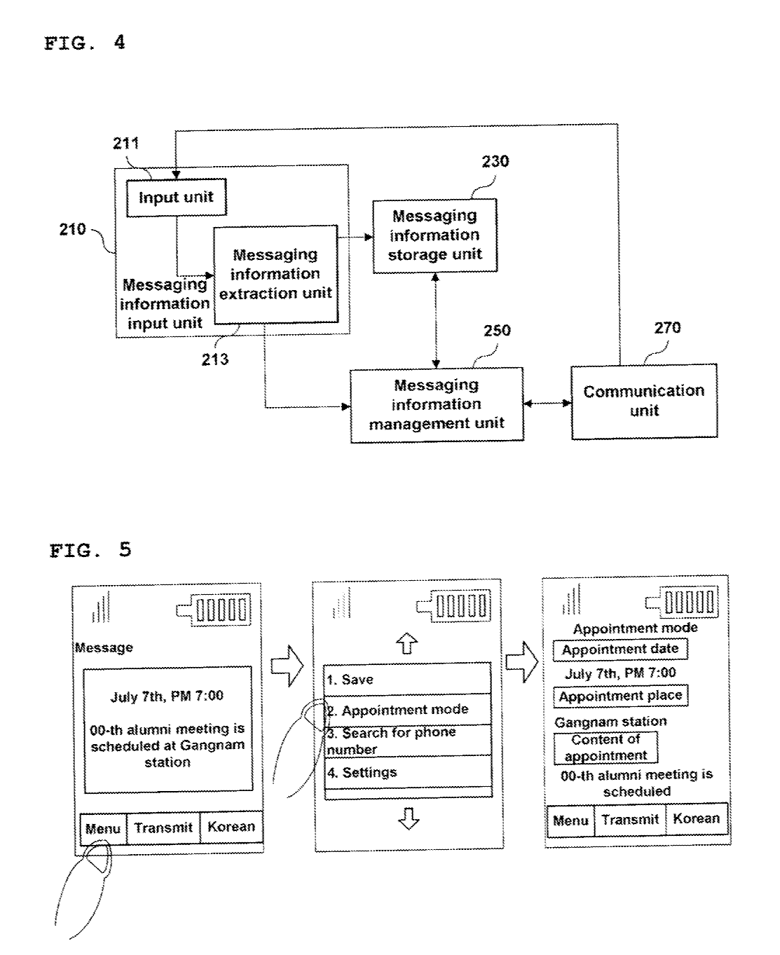

FIG. 4 is a block diagram showing a portable terminal using a messaging information providing apparatus related to the present invention.

Referring to FIG. 4, the portable terminal includes a messaging information input unit 210 provided with an input unit for receiving text from a user and a messaging information extraction unit for extracting messaging information of each management item contained in the text by matching the text against messaging information keywords stored in a keyword database (not shown) by management item, a messaging information storage unit 230 for storing, by management item, the messaging information extracted by the messaging information extraction unit, a messaging information management unit 250 for driving a process related to messaging information of a management item selected by the user, in association with messaging information of other management items extracted from the same text, and a communication unit 270 for transmitting and receiving a result of the process driven by the messaging information management unit through a mobile communication network.

The messaging information input unit 210 includes the input unit 211 for receiving text: from a user and the messaging information extraction unit 213 for extracting messaging information of each management item from the text. The input unit may receive text inputted by the user himself or herself or text transmitted from outside through the communication unit 270. The keyword database involved in the messaging information extraction process of the messaging information extraction unit is the same as described above.

The messaging information storage unit 230 stores, by management item, the messaging information extracted by the messaging information extraction unit. The messaging information storage unit may be allocated with and use existing memory provided in the portable terminal. Here, it is noted that the messaging information storage unit in the present embodiment of a portable terminal is not a memory unit for temporarily storing data processed by a processor performing a certain process, but a storage device for storing data for an extended period of time such as a hard disk of a computer. A storage unit corresponding to the concept of the temporary storage memory is assumed to be included in the messaging information management unit.

The management items may be defined by items such as a date, a place and the like requested in the text such as a request for a call, an order of a call connection, a request for an interview, a report/approval, a request for a meeting, a request for a luncheon, a request for a dinner, a family affair, an event, a supporting group, a proposal/petition, and others.

The messaging information management unit 250 manages messaging information stored in the messaging information storage unit or messaging information extracted by the messaging information extraction unit, and the management includes processing the messaging information. A process related to the messaging information refers to editing and displaying the messaging information in a form desired by the user.

Accordingly, the process is selected by the user, and at least the messaging information desired by the user is processed as target data of the selected process. For example, if a management item relates to an appointment, and the user desires to view appointment time messaging information related to an appointment time management item among the messaging information stored in the messaging information storage unit, a process of loading and displaying the messaging information stored in the appointment time management item is the process related to the messaging information.

Describing another specific example of the process, there is a case where a company's overall schedule and a personal schedule are displayed monthly, daily and hourly. If a user selects a corresponding month, date or time, the user is allowed to write characters on a corresponding window, and different colors may be used for the displayed characters depending on the type of the schedule so as to distinguish the schedule.

In addition, the portable terminal may also provide a cellular phone message notification function, an automatic call connection function, a user name database, and a community vitalization function. For example, the cellular phone message notification function provides a function of extracting and processing a call log, which are transferred only using a post-it or a note, as messaging information and sending the call log as a cellular phone message or an e-mail. As another example, the automatic call connection function provides a function of automatically making a phone call by only clicking a call button of a phone number displayed on a program screen without separately pressing the phone number when a user makes a phone call. As still another example, a user name database construction function provides a function of constructing a user name database so that information on an address book of a user may be shared among users and thus the users may easily use data related to user names. As still another example, the community vitalization function provides various kinds of information and makes comments on a problem (of course, it should include messaging information) through a community of users using a program, and provides a solution to troubles of a user such as searching for a delicious restaurant or the like. If there is a plurality of users, additional functions such as a phone call memo function for prompting a notice on a pop-up window when a certain user logs in and a favorite function for directly linking to a favorite site so that a user may rapidly and easily use information. It is apparent that the user name and the site described above are processed as messaging information.

In addition, the messaging information management unit drives a process related to messaging information of a management item selected by the user, in association with messaging information of other management items extracted from the same text. When appointment time messaging information is displayed in the example described above, messaging information such as appointment place messaging information and appointment content messaging information extracted from the same text of the appointment time messaging information is display together in association with the appointment time messaging information. It is apparent that the associated messaging information may be displayed in a variety of methods depending on a user's taste, or in some cases, they may not be displayed.

The messaging information storage unit may output an output material of message content information, schedule information, and address information stored in the messaging information storage unit, in a form desired by a user by the type of the information.

The output material is outputted in the form of a business with people contacting the user, an appointment for a meal, a request for report and approval of a meeting interview, a list of unprocessed telephone interviews, a guide to family affairs and events, an output of the entire schedule note, a comprehensive report for each business item, people who desire to report and be approved, people submitting a proposal or a petition, people sending a New Year's greeting card, a guide to other messages, a daily schedule, a weekly schedule, a monthly schedule, or a memo.

In addition, the messaging information management unit may embeds additional information (today's actual date or the like) for messaging information that needs to be set based on the current date such as ‘this day’, ‘today’, or ‘tomorrow’. It is apparent that the additional information does not need to be embedded if the messaging information input unit, specifically, the messaging information extraction unit embeds the additional information.

The communication unit 270 transmits and receives a result of the process driven by the messaging information management unit through a mobile communication network.

If the messaging information received through the communication unit corresponds to management items including at least an appointment date, an appointment place, and content of appointment, the messaging information management unit stores the messaging information in the messaging information storage unit by management item, and if one of appointment date messaging information, appointment place messaging information, and appointment content messaging information is selected, the messaging information management unit also displays the other information in association with the selected information. If the messaging information received through the communication unit is text, the messaging information management unit may transfers the text from the communication unit to the input unit.

If the management items include at least an appointment date, an appointment place, and content of the appointment, the messaging information management unit may extract messaging information associated within the management items, display the associated messaging information, and transmit the associated messaging information to outside through the communication unit depending on a user's selection.

In addition, the messaging information management unit may store call connection numbers of one or more receiver terminals, which are targets for transmitting a result of the process, in a receiver terminal group, and edit the receiver terminal group and transmit an additional process to the receiver terminal group upon the request of the user.

The communication unit may include a mobile communication module for communicating with outside.

An example of the portable terminal described above will be described with reference to FIGS. 5 to 8.

First, as shown in FIG. 5, a user creates a short message such as ‘July 7^{th} PM 7:00, Gangnam station, 00-th alumni meeting is scheduled’ (the figure on the left side of FIG. 5). If the Transmit button at the lower portion is pressed in this state, the short message is transmitted to the counterpart as is. If the user desires to process a corresponding message in an appointment mode, the user selects the appointment mode through a variety of user interfaces (the figure in the middle of FIG. 5). In FIG. 5, ‘2. Appointment mode’ is shown in the submenu of the Menu button shown at the lower portion of the screen. If the user selects the Appointment mode, the messaging information extraction unit extracts ‘July 7^{th} PM 7:00’, ‘Gangnam station’, and ‘00-th alumni meeting is scheduled’ respectively corresponding to management items of ‘appointment date’, ‘appointment place’, and ‘content of appointment’ from the short message inputted by the user. The messaging information management unit receives the messaging information extracted by the messaging information extraction unit and displays the messaging information to be correspondent to the management items (the figure on the right side of FIG. 5). Thereafter, the user transmits the messaging information related to an appointment to a desired receiver.

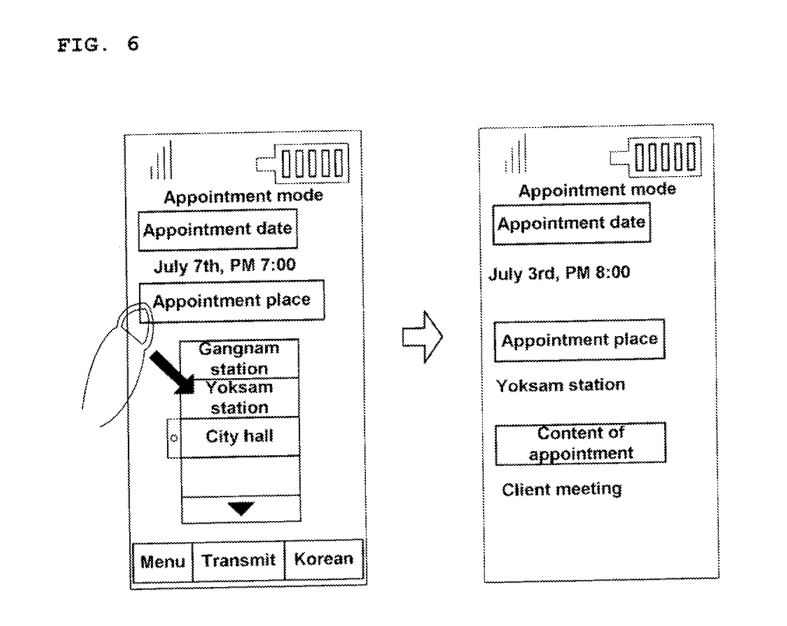

The extracted messaging information may be stored in the messaging information storage unit by management item depending on a user's selection (e.g., ‘Menu’ at the lower portion of the screen is selected, and then ‘Save’ is selected from the submenu). Since the messaging information is stored by management item, the user may search for the messaging information by each management item in an appointment mode screen as shown in FIG. 6. If the user selects management item ‘Appointment place’ in the figure on the left side of FIG. 6, ‘Gangnam station’, ‘Yoksam station’, and ‘City hall’ stored in the appointment place management item of the messaging information storage unit are displayed as a submenu. If the user selects Yoksam station in this state, messaging information ‘Yoksam station’ is processed and displayed in association with ‘July 3^{rd} PM 8:00’ and ‘client meeting’ extracted from the same text (the figure on the right side of FIG. 6).

Meanwhile, association among the messaging information stored in the messaging information storage unit may be diversely applied. For example, if July 7^{th} is selected from a calendar display screen as shown in FIG. 7, messaging information related to the appointment place and the content of appointment associated with messaging information corresponding to July 7^{th} is displayed at a certain position. Other than this, if a new day begins after midnight, messaging information related to the new day may be displayed.

In the case of messaging information related to an appointment, a transmitter needs to recognize whether or not a receiver receives and confirms the messaging information related to a corresponding appointment. In addition, although the receiver confirms the messaging information, it needs to recognize whether or not the receiver raises an objection to the time and place contained in the messaging information related to the corresponding appointment.

That is, the transmitter needs to manage whether or not the receiver confirms the messaging information, whether or not the receiver will participate in the meeting, and the like together with the messaging information related to the appointment. In this situation, the transmitter may have difficulties in separately managing receivers who do not confirm the messaging information or express unwillingness to participate in the meeting. Accordingly, the messaging information management unit may store call connection numbers of one or more receiver terminals, which are targets for transmitting a result of the process, in a receiver terminal group, and edit the receiver terminal group and transmit an additional process to the receiver terminal group upon the request of the user, considering convenience of users.

According to this, if messaging information related to an appointment (a result of the process) created by the transmitter is transmitted to the receiver, the call connection number of the receiver is stored in the receiver terminal group. If the transmitter desires to know whether or not the receiver confirms the messaging information related to the appointment, the messaging information management unit inserts a confirmation request message in the messaging information related to the appointment, and the receiver terminal group is updated if a confirmation message is received from the receiver. The confirmation request message may be embedded in the messaging information related to the appointment, or the user may separately create the confirmation request message and connect or associate the separately created confirmation request message with the messaging information related to the appointment. For example, if the receiver terminal group includes a plurality of receiver call connection numbers, the user edits the receiver terminal group to separate call connection numbers of receivers who transmit a confirmation message from call connection numbers of receivers who do not transmit a confirmation message. The separated receiver call connection numbers are preferably provided in a form that can be confirmed by the user as needed. For example, if receiver call connection numbers 1, 2, 3, 4 and 5 are stored in the receiver terminal group and call connection numbers of receiver who transmit a confirmation message are 1, 3 and 4, the receiver call connection numbers can be separated and displayed in a form using ‘O’ or ‘X’, such as call connection number 1O, call connection number 3O, call connection number 4O, call connection number 2X, and call connection number 5X. If the transmitter requests confirmation of a receiver again, only the receiver terminals other than the receiver terminals which have already transmitted a confirmation message (call connection numbers 2 and 5) are selected and the messaging information related to the appointment is retransmitted, or a message requesting to confirm the previously transmitted messaging information related to the appointment may be transmitted to all the receiver terminals. There may be a case where a receiver expresses unwillingness to participate in the meeting held at the time and place specified in the messaging information related to the appointment, through a confirmation message or other communication means. Depending on the nature of the appointment, the transmitter may exclude the receiver who expresses unwillingness to participate in the meeting or change the time and place so that the receiver may participate in the meeting. In the latter case, the transmitter may construct new messaging information related to the appointment with an available time and place of the receiver who has expressed unwillingness to participate in the meeting (transmission of an additional process). At this point, the transmission target will be all the terminals in the receiver terminal group regardless of whether or not the receivers have transmitted a confirmation message. Even at this point, the messaging information management unit may process the transmission for all the terminals in the receiver terminal group, and thus the transmitter does not need to create the receiver call connection numbers.

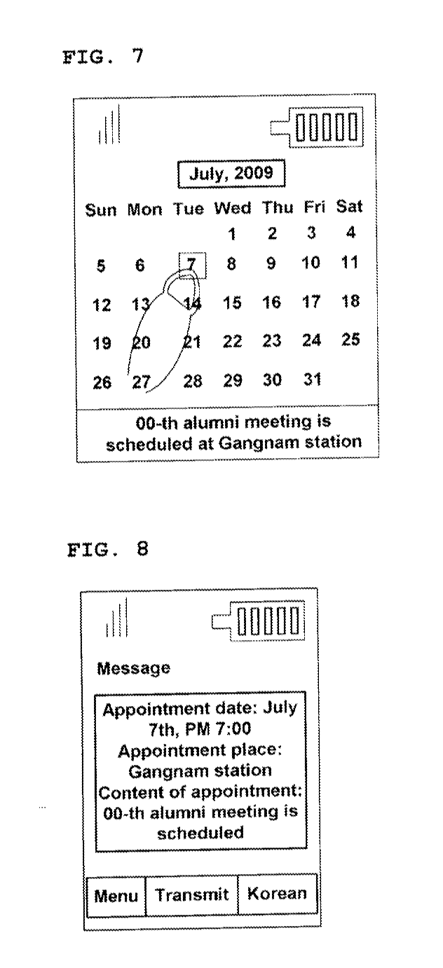

Meanwhile, in the case where appointment information is transmitted in an appointment mode as shown in FIG. 5, if the portable terminal receiving the appointment information includes the messaging information management unit and the like, the appointment information may be displayed as is in the appointment mode, but there may be portable terminals that do not support the appointment mode. In this case, the appointment information may be displayed in the form of a short message as is inputted by a user as shown in the figure on the left side of FIG. 5, or the appointment information may be displayed as a short message as shown in FIG. 8, in which management items such as ‘Appointment date’, ‘Appointment place’, and ‘Content of appointment’ may be added as identifiers.

The portable terminal according to the present embodiment described above extracts one or more pieces of messaging information from the text inputted by the user and manages the extracted messaging information to associate with one another, and thus the user may easily input the messaging information and efficiently manage the messaging information. In addition, the user may easily manage text transmitted from outside.

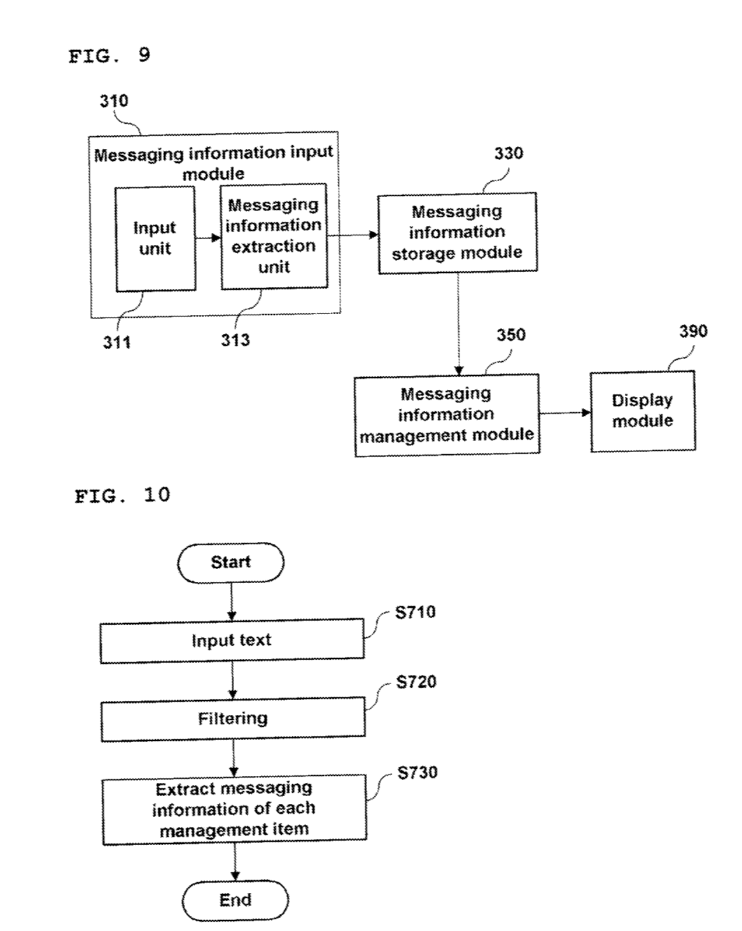

An example of applying the apparatus and method for providing and managing messaging information to a portable terminal is described above, and hereinafter, a messaging information management system of a further extended range will be described with reference to FIG. 9.

FIG. 9 is a block diagram showing a messaging information management system related to the present invention.

Referring to FIG. 9, the messaging information management system according to the present invention includes a messaging information input module 310 provided with an input unit for receiving text from a user and a messaging information extraction unit for extracting messaging information of each management item contained in the text by matching the text against messaging information keywords stored in a keyword database by management item, a messaging information storage module 330 for storing, by management item, the messaging information extracted by the messaging information extraction unit, a messaging information management module 350 for driving a process related to messaging information of a management item selected by the user, in association with messaging information of other management items extracted from the same text, and a display module 390 for displaying a result of the process driven by the messaging information management module.

Since the messaging information is information related to a user's schedule such as a time, a place, and main content desired to inform, the process related to the messaging information may include at least any one of contact information display, schedule display, and appointment display. That is, the process is a process required to display messaging information desired by the user, together with associated messaging information. Specific views of the association are the same as described above in the portable terminal, and detailed description of each component is described above and thus will be omitted.

Each of the modules described above may be disposed in a separate terminal or a server, and some of the components may be combined and disposed in the terminal or the server.

For example, the input unit of the messaging information input module and the display module are preferably disposed in the same terminal. It is since that both the input unit 311 and the display module 390 are components directly contacted with a user. The input unit for accomplishing input of text containing messaging information, which is the main interest of the present embodiment, by the user and the display module for displaying the messaging information to the user who desired to visually acquire the extracted messaging information to be suitable for the object are disposed in the same terminal, and eventually, the user may easily process input and display of desired messaging information.

Meanwhile, the messaging information extraction unit 313 of the messaging information input module, the messaging information storage module 330, the messaging information management module 350, and the keyword database 390 may be provided in the server. A plurality of users may easily share the messaging information through these constitutional components. It is preferable that the server includes an authentication module for allowing access to the server through a user's authentication.

It is apparent that the messaging information extraction unit, the messaging information storage module, and the messaging information management module may be included in one portable terminal, and the portable terminal may include even the input unit and the display module. Security can be maintained by further including the authentication module in the portable terminal.

Describing association of the messaging information accomplished in the messaging information management module, the messaging information extracted by the messaging information extraction unit at the current time point can be processed as messaging information associated with one another, and thus there is not a special problem. However, if messaging information received from the messaging information management module passes through the messaging information storage module, the messaging information storage module should store indication of associated messaging information in each of the messaging information.

Accordingly, the messaging information storage module 330 may embed a connector associated with other connectors in each of the extracted messaging information and store the messaging information embedded with the connector by management item. At this point, the messaging information management module 350 may acquire messaging information associated with the messaging information selected by the user, from the messaging information storage module using the connector.

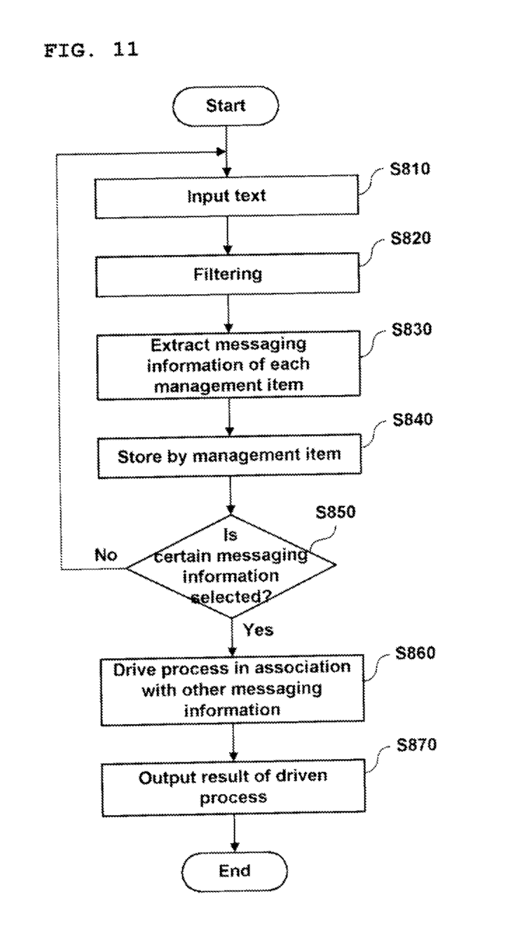

FIG. 10 is a flowchart illustrating a messaging information providing method related to the present invention.

First, text is received from a user S710. It is assumed that the input text includes messaging information. If the messaging information is not included, this will be notified to the user. The text may be text currently inputted by the user, text stored in a certain storage device, text received from outside, or the like.

If the text is inputted by the user, messages unrelated to the messaging information are filtered from the inputted text using a keyword database previously storing keywords of the messaging information S720. It is described above that reliability of extracting the messaging information may be improved by performing the filtering, and messaging information that is difficult to extract may also be easily extracted through the keyword database at a later time.

The messaging information of each management item contained in the filtered text is extracted by comparing the filtered text with the messaging information keywords stored in the keyword database by management item S730.

In this manner, the messaging information of each management item may be extracted from the text inputted by the user, and the messaging information may be easily managed at a later time by extracting the messaging information of each management item.

FIG. 11 is a flowchart illustrating a messaging information management method related to the present invention.

Text is received from a user S810, and messages unrelated to the messaging information are filtered from the received text using a keyword database previously storing keywords of the messaging information S820.

The messaging information of each management item contained in the filtered text is extracted by comparing the filtered text with the messaging information keywords stored in the keyword database by management item 5830.

A connector associated with other connectors is embedded in each of the extracted messaging information, and the messaging information embedded with the connector is stored by management item S840.

A process related to messaging information management item selected S850 by the user is driven, and the process is driven in association with messaging information of other management items associated with the selected messaging information through the connector S860.

A result of the process driven as described above is outputted 5870.

Meanwhile, the method may further include the step of authenticating a user before the text input step.

The process may include at least any one of contact information display, schedule display, and appointment display.

The management item may include at least one of message content, an address, and a schedule.

Meanwhile, the messaging information management system described above may be recorded in a computer readable medium as a program.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

An apparatus and a method for providing messaging information and a portable terminal using the same according to the present invention may be applied to a portable terminal, a schedule management server, a schedule management terminal, and a secretary work management system.

1. A messaging information providing apparatus comprising:
an input unit for receiving text from a user; and
a messaging information extraction unit for extracting messaging information of each management item contained in the text by matching the text against messaging information keywords stored in a keyword database by management item.

2. The apparatus according to claim 1, further comprising a preprocessing unit for filtering messages unrelated to the messaging information using the keyword database and transmitting the filtered text to the messaging information extraction unit, after analyzing the text inputted by the user.

3. The apparatus according to claim 1, further comprising a display unit for displaying, by management item, the messaging information extracted by the messaging information extraction unit.

4. The apparatus according to claim 3, wherein if the user manually inputs the text in a displayed management item, the keyword database additionally stores the manually inputted text as a keyword of the management item.

5. The apparatus according to claim 1, further comprising a messaging information storage unit for storing, by management item, the messaging information extracted by the messaging information extraction unit.

6. The apparatus according to claim 1, wherein the management item includes at least one of message content, an address, and a schedule.

7. The apparatus according to claim 1, wherein the text contains special characters set for each management item in the keyword database.

8. A portable terminal comprising:
a messaging information input unit provided with an input unit for receiving text from a user and a messaging information extraction unit for extracting messaging information of each management item contained in the text by matching the text against messaging information keywords stored in a keyword database by management item;
a messaging information storage unit for storing, by management item, the messaging information extracted by the messaging information extraction unit;
a messaging information management unit for driving a process related to messaging information of a management item selected by the user, in association with messaging information of other management items extracted from the same text; and
a communication unit for transmitting and receiving a result of the process driven by the messaging information management unit through a mobile communication network.

9. The terminal according to claim 8, wherein the management item includes at least an appointment date, an appointment place, and content of appointment, and the messaging information management unit extracts and displays messaging information associated within the management items and transmits the messaging information to outside through the communication unit depending on a user's selection.

10. The terminal according to claim 8, wherein the communication unit receives messaging information from outside, and if the received messaging information corresponds to management items containing at least an appointment date, an appointment place, and content of appointment, the messaging information management unit stores the messaging information in the messaging information storage unit by management item, and if one of appointment date messaging information, appointment place messaging information, and appointment content messaging information is selected, the messaging information management unit displays the other information in association with the selected information.

11. The terminal according to claim 8, wherein the messaging information management unit stores call connection numbers of one or more receiver terminals, which are targets for transmitting a result of the process, in a receiver terminal group, and edits the receiver terminal group and transmits an additional process to the receiver terminal group upon a request of the user.

12. A messaging information management system comprising:
a messaging information input module provided with an input unit for receiving text from a user and a messaging information extraction unit for extracting messaging information of each management item contained in the text by matching the text against messaging information keywords stored in a keyword database by management item;
a messaging information storage module for storing, by management item, the messaging information extracted by the messaging information extraction unit;
a messaging information management module for driving a process related to messaging information of a management item selected by the user, in association with messaging information of other management items extracted from the same text; and
a display module for displaying a result of the process driven by the messaging information management module.

13. The system according to claim 12, wherein the process includes at least any one of contact information display, schedule display, and appointment display.

14. The system according to claim 12, wherein the input unit of the messaging information input module and the display module are disposed in a same terminal.

15. The system according to claim 12, wherein the messaging information extraction unit of the messaging information input module, the messaging information storage module, the messaging information management module, and the keyword database are provided in a server, and the server includes an authentication module for allowing access to the server through a user's authentication.

16. The system according to claim 12, wherein the messaging information storage module embeds a connector associated with other connectors in each of the extracted messaging information and stores the messaging information by management item, and the messaging information management module acquires messaging information associated with the messaging information selected by the user using the connector.

17. A messaging information providing method comprising:
receiving text from a user;
filtering messages unrelated to messaging information from the received text using a keyword database previously storing keywords of the messaging information; and
extracting messaging information of each management item contained in the filtered text by comparing the filtered text with the messaging information keywords stored in the keyword database by management item.

18. A messaging information management method comprising:
receiving text from a user;
filtering messages unrelated to messaging information from the received text using a keyword database previously storing keywords of the messaging information;
extracting messaging information of each management item contained in the filtered text by comparing the filtered text with the messaging information keywords stored in the keyword database by management item;
embedding a connector associated with other connectors in each of the extracted messaging information, and storing the messaging information embedded with the connector by management item;
driving a process related to messaging information of a management item selected by the user;
driving the process in association with messaging information of other management items associated with the selected messaging information through the connector; and
outputting a result of the driven process.

19. The method according to claim 18, further comprising authenticating a user before the text is input.

20. The method according to claim 18, wherein the process includes at least any one of contact information display, schedule display, and appointment display.

21. A text analysis method comprising:
receiving text;
extracting a special character from the text; and
storing a character string starting from a character next to the extracted special character to a character before a next special character to be correspondent to a management item which defines the extracted special character.

22. A text analysis method comprising:
receiving text;
extracting a word defined for each management item from the text; and
storing a character string following the extracted word without a space character to be correspondent to the management item which defines the extracted word.

23. The method according to claim 21, wherein the management item includes at least one of a time, a place, a topic, and others.

24. The method according to claim 22, wherein the extracted word is positioned at an end of the character string.

25. The method according to claim 22, wherein the extracted word is a longest word among a plurality of words containing a same syllable.

26. The method according to claim 22, wherein the management item includes at least one of a time, a place, a topic, and others.
